(19) United States
(12) Patent Application Publication
(10) Pub. No.: US 2025/0386098 A1
(43) Pub. Date: Dec. 18, 2025

(54) METHOD FOR FAST FOCUSING BASED ON FREQUENCY DOMAIN LINNIK INTERFEROMETRY

(71) Applicant: KLA Corporation, Milpitas, CA (US)

(72) Inventor: Avner Safrani, Mitzpe Aviv (IL)

(21) Appl. No.: 18/742,463

(22) Filed: Jun. 13, 2024

(51) Int. Cl. H04N 23/67; G01J 3/45; G02B 7/40; H04N 23/71; H04N 23/74

(52) U.S. Cl. CPC H04N 23/671; G01J 3/45; G02B 7/40; H04N 23/71; H04N 23/74

(57) ABSTRACT

The system may include an imaging subsystem, a focusing subsystem, and a processor. The imaging subsystem includes a light source configured to emit light, a main objective lens configured to focus the light onto a sample, and a camera configured to generate one or more images of the sample based on the light emitted from the light source reflected by the sample. The focusing subsystem includes a reference objective lens configured to focus a portion of the light onto a reference mirror that is reflected and collocated with the light reflected by the sample, and a spectrometer configured to generate an interference signal based on the collocated light reflected by the sample and the reference mirror. The processor is configured to transform the interference signal from a time-domain signal to a frequency-domain signal and determine a defocus condition of the imaging subsystem based on the frequency-domain signal.

### FIELD OF THE DISCLOSURE

This disclosure relates to semiconductor inspection systems and, more particularly, to autofocusing systems for semiconductor inspection.

### BACKGROUND OF THE DISCLOSURE

Evolution of the manufacturing industry is placing greater demands on yield management and, in particular, on metrology and inspection systems. Critical dimensions continue to shrink, yet the industry needs to decrease time for achieving high-yield, high-value production. Minimizing the total time from detecting a yield problem to fixing it maximizes the return-on-investment for a manufacturer.

Inspection processes are used at various steps during semiconductor manufacturing to detect defects on wafers to promote higher yield in the manufacturing process and, thus, higher profits. Inspection has always been an important part of fabricating semiconductor devices such as integrated circuits (ICs). However, as the dimensions of semiconductor devices decrease, inspection becomes even more important to the successful manufacture of acceptable semiconductor devices because smaller defects can cause the devices to fail. For instance, as the dimensions of semiconductor devices decrease, detection of defects of decreasing size has become necessary because even relatively small defects may cause unwanted aberrations in the semiconductor devices.

Optical metrology and inspection tools are often used to monitor, measure, and control the process of electronic chips manufacturing. Typically, these tools include an optical microcopy arrangement where an objective lens is used to image process defects, contaminating particles, trenches, vias, metrology targets, etc. In many cases, specifically in metrology tools where an accurate measurement of some feature is required, the focus quality of the measuring equipment has a significant impact on the accuracy and precision of the measurement while the focus speed has high impact on the throughput of the tool. Hence, a fast, accurate, and repeatable focus system is a target function of these tools.

Focus systems are generally implemented as an out of the lens (OTL) focus system or a through the lens (TTL) focus system. Generally, OTL focus systems are less accurate, as they operate far away from the measurement and there can be ambiguity regarding the real focus of the system relative to the measuring location. TTL focus systems measure right on the spot where the measurement takes place, so they can be more accurate and correlate with the optical system real focus during the measurement.

TTL focus systems may be implemented using the inherent illumination of the tool or by using an independent light source. An independent illumination source can be easier to shape, manipulate, and control the power of the probing beam, but, in some cases, using a different wavelength band for imaging and focusing can interact differently with the sample and produce inaccurate results. Furthermore, many focus systems require mechanical moving parts to detect the defocusing by scanning the sample along a vertical axis, but such movement can limit the speed, accuracy, and repeatability of the focus measurement.

Therefore, what is needed is an focusing system having improved speed, accuracy, and repeatability.

### BRIEF SUMMARY OF THE DISCLOSURE

An embodiment of the present disclosure provides a system. The system may comprise an imaging subsystem, a focusing subsystem, and a processor. The imaging subsystem may comprise a light source configured to emit light, a main objective lens configured to focus the light onto a sample, and a camera configured to generate one or more images of the sample based on the light emitted from the light source reflected by the sample. The focusing subsystem may comprise a reference objective lens configured to focus a portion of the light onto a reference mirror, the reference mirror being configured to reflect light to be collocated with the light reflected by the sample, and a spectrometer configured to generate an interference signal based on the collocated light reflected by the sample and the reference mirror. The interference signal may be a time-domain signal. The processor may be in electronic communication with the spectrometer. The processor may be configured to transform the interference signal to obtain a frequency-domain signal and determine a defocus condition of the imaging subsystem based on the frequency-domain signal.

In some embodiments, the processor may be configured to transform the interference signal by applying a Fourier transform to the interference signal, and the processor may be configured to obtain the defocus condition by determining a local maximum of the frequency-domain signal using a side lob peak finding algorithm, a center of mass algorithm, or a deep learning model.

In some embodiments, the focusing subsystem may further comprise a glass block disposed in the path of the light reflected by the reference mirror. The glass block may be configured to induce a phase delay between the light reflected by the sample and the light reflected by the reference mirror.

In some embodiments, the imaging subsystem may further comprise a stage configured to move in an axial direction to adjust a distance between the main objective lens and the sample. The defocus condition may comprise an axial distance between a present defocused position and a focused position in which the imaging subsystem is in focus with the sample. The processor may be in electronic communication with one or more actuators configured to move the stage in the axial direction, and the processor may be further configured to send instructions to the one or more actuators to move the stage from the present defocused position to the focused position.

In some embodiments, the focusing subsystem may further comprise a shutter that is movable within the path of the light reflected by the reference mirror to selectively allow the light to be collocated with the light reflected by the sample in a first position and block the light from being collocated with the light reflected by the sample in a second position. The processor may be in electronic communication with one or more actuators configured to move the shutter, and the processor may be further configured to send instructions to the one or more actuators to move the shutter from the first position to the second position after determining the defocus condition of the imaging subsystem.

In some embodiments, the processor may be configured to send instructions to the one or more actuators to move the shutter from the first position to the second position simultaneously as the stage moves from the defocused position to the focused position.

In some embodiments, the processor may be in electronic communication with the camera, and the processor may be further configured to send instructions to the camera to capture the one or more images of the sample after the stage is moved from the present defocused position to the focused position.

In some embodiments, the focusing subsystem may further comprise a focusing light source configured to generate a focus light of a different wavelength spectrum from the light from the light source of the imaging subsystem. The focus light may be reflected by the sample and the reference mirror. The focusing subsystem may further comprise a first filter disposed in the path of the focus light reflected by the reference mirror. The first filter may be configured to transmit the focus light from the focusing light source to be reflected by the reference mirror and reflect the light from the light source of the imaging subsystem toward a first beam dump. The focusing subsystem may further comprise a second filter disposed in the path of the collocated focus light reflected by the sample and the reference mirror. The second filter may be configured to transmit the reflected focus light to be received by the spectrometer and reflect the light from the light source of the imaging subsystem toward a second beam dump. The spectrometer may be configured to generate the interference signal based on the collocated focus light reflected by the sample and the reference mirror.

In some embodiments, the first filter may be further configured to induce a phase delay between the focus light reflected by the sample and the focus light reflected by the reference mirror.

In some embodiments, the processor may be in electronic communication with the focusing light source, and the processor may be further configured to send instructions to turn off the focusing light source after the stage is moved from the present defocused position to the focused position.

In some embodiments, the focusing subsystem may comprise a plurality of focusing light sources having different bandwidths, and the processor may be further configured to send instructions to turn on one of the plurality of focusing light sources based on the wavelength spectrum of the light from the light source of the imaging subsystem.

Another embodiment of the present disclosure provides a method for focusing an imaging subsystem. The method may comprise: emitting light from a light source that is focused onto a sample by a main objective lens and focused onto a reference mirror by a reference objective lens, wherein the light is reflected by the sample and reflected by the reference mirror into a collocated light path; generating, with a spectrometer, an interference signal based on the collocated light reflected by the sample and the reference mirror, wherein the interference signal is a time-domain signal; transforming, with a processor, the interference signal to obtain a frequency-domain signal; and determining, with the processor, a defocus condition of the imaging subsystem based on the frequency-domain signal.

In some embodiments, transforming, with the processor, the interference signal to obtain the frequency-domain signal may comprise applying a Fourier transform to the interference signal. In some embodiments, determining, with the processor, the defocus condition of the imaging subsystem based on the frequency-domain signal may comprise determining the defocus condition of the imaging subsystem based on a local maximum of the frequency-domain signal.

In some embodiments, the method may further comprise moving a stage in an axial direction from a present defocused position to a focused position according to the defocus condition to adjust a distance between the main objective lens and the sample.

In some embodiments, the method may further comprise moving a shutter into the path of the light reflected by the reference mirror to block the light from being collocated with the light reflected by the sample.

In some embodiments, the shutter may be moved simultaneously with the stage.

In some embodiments, the method may further comprise capturing, with a camera, one or more images of the sample based on the light from the light source reflected by the sample with the stage located in the focused position.

In some embodiments, the method may further comprise emitting a focus light with a focusing light source, wherein the focus light has a different wavelength spectrum from the light from the light source, and the focus light is reflected by the sample and reflected by the reference mirror into the collocated light path. A first filter disposed in the path of the focus light reflected by the reference mirror may be configured to transmit the focus light from the focusing light source to be reflected by the reference mirror and reflect the light from the light source of the imaging subsystem toward a first beam dump. A second filter disposed in the path of the collocated focus light reflected by the sample and the reference mirror may be configured to transmit the reflected focus light to be received by the spectrometer and reflect the light from the light source of the imaging subsystem toward a second beam dump. In some embodiments, generating, with the spectrometer, the interference signal based on the collocated light reflected by the sample and the reference mirror may comprise generating an interference signal based on the collocated focusing light reflected by the sample and the reference mirror.

In some embodiments, emitting the focus light with the focusing light source may comprise: selecting, with the processor, a focusing light source of a plurality of focusing light sources based on the wavelength spectrum of the light from the light source of the imaging subsystem, wherein each of the plurality of focusing light sources have different bandwidths; and emitting the focus light with the selected focusing light source.

In some embodiments, before capturing, with the camera, the one or more images of the sample, the method may further comprise turning off the focusing light source to stop emitting the focus light.

### DESCRIPTION OF THE DRAWINGS

For a fuller understanding of the nature and objects of the disclosure, reference should be made to the following detailed description taken in conjunction with the accompanying drawings, in which:

FIG. 1 is a diagram of a system according to an embodiment of the present disclosure, in which a shutter is disposed in a first position for determining a defocus condition;

FIG. 2 is a diagram of the system of FIG. 1, in which the shutter is disposed in a second position for imaging a sample;

FIG. 3 is a diagram of a system according to another embodiment of the present disclosure;

FIG. 4 is a diagram of a system according to another embodiment of the present disclosure, in which a focusing light is turned on for determining a defocus condition;

FIG. 5 is a diagram of the system of FIG. 4, in which the focusing light is turned off for imaging a sample;

FIG. 6 is a graph of an interference signal measured by a spectrometer of a system of the present disclosure, in which the interference signal is a time-domain (spectral) signal;

FIG. 7 is a graph of the interference signal of FIG. 6 transformed into a frequency-domain (Fourier) signal;

FIG. 8 is a flowchart of a method according to an embodiment of the present disclosure;

FIG. 9 is a flowchart of a method according to another embodiment of the present disclosure; and

FIG. 10 is a flowchart of a method according to another embodiment of the present disclosure.

### DETAILED DESCRIPTION OF THE DISCLOSURE

Although claimed subject matter will be described in terms of certain embodiments, other embodiments, including embodiments that do not provide all of the benefits and features set forth herein, are also within the scope of this disclosure. Various structural, logical, process step, and electronic changes may be made without departing from the scope of the disclosure. Accordingly, the scope of the disclosure is defined only by reference to the appended claims.

An embodiment of the present disclosure provides a system 100. The system 100 may be a semiconductor inspection or metrology system configured to process a sample 101. The sample 101 may be a semiconductor wafer, substrate, chip, IC, flat panel display, or other type of workpiece and is not limited herein. The sample 101 may be disposed on a sample stage 105 configured to hold the sample 101. The system 100 may comprise an imaging subsystem 102 and a focusing subsystem 103. As further described herein, the imaging subsystem 102 and the focusing subsystem 103 may cooperate for fast focusing and imaging of the sample 101.

The imaging subsystem 102 may comprise a light source 110. The light source 110 may be a broadband light source having an illumination spectrum within a range of 300 nm to 1050 nm. In some embodiments, the illumination spectrum of the light source 110 may be within the range of 900 nm to 1700 nm. The light source 110 may be configured to emit light 111. The light 111 may be directed onto the sample 101 by one or more optical components. For example, an illumination lens 112, a first beam splitter 113, and a main objective lens 114 may be disposed in the path of light emitted by the light source 110.

The imaging subsystem 102 may further comprise a camera 120. The camera 120 may be configured to capture one or more images of the sample 101 based on the light 111 emitted by the light source 110 reflected by the sample 101. One or more optical components may be disposed in the path of the light 121 reflected by the sample 101. For example, an imaging lens 122 and a second beam splitter 123 may be disposed in the path of the light 121 reflected by the sample 101.

In some embodiments, the imaging subsystem 102 may comprise a vertical stage (not shown) configured to hold one or more optical elements of the imaging subsystem 102 (e.g., illumination lens 112, first beam splitter 113, reference objective lens 132, reference mirror 130, main objective lens 114, etc.). The vertical stage may be movable in an axial direction to adjust a distance between the main objective lens 114 and the sample 101, rather than the sample stage 105 which moves the sample 101 relative to the main objective lens 114. In either case, the sample stage 105 or the vertical stage may be movable in the axial direction using one or more actuators such as a linear motor with a cross bearing or air bearings. In some embodiments, on the one or actuators could comprise a ball screw drive or a piezo based actuator configured to move the sample stage 105 or the vertical stage in the axial direction.

In some embodiments, the imaging subsystem 102 may be a microscopy system. For example, the imaging subsystem 102 may be configured as a bright field imaging system, dark field imaging system, confocal imaging system, structured light microscopy system, polarimetric microscopy system, ellipsometry system, or holography microscopy system and is not limited herein. In other embodiments, the imaging subsystem 102 may be part of a front end OVL metrology equipment, wafer to wafer alignment metrology equipment, or die to wafer (D2 W) metrology equipment, or other types of metrology systems and is not limited herein.

The focusing subsystem 103 may comprise a reference mirror 130. The reference mirror 130 may be configured to reflect light to be collocated with the light reflected by the sample 101. For example, the first beam splitter 113 may be configured to direct a portion 131 of the light 111 emitted by the light source 110 toward the reference mirror 130, which is then reflected back to be collocated with the light reflected by the sample 101. One or more optical components may be disposed in the path of the light 131 incident on the reference mirror 130. For example, a reference objective lens 132 may be disposed in the path of the light 131 incident on the reference mirror 130.

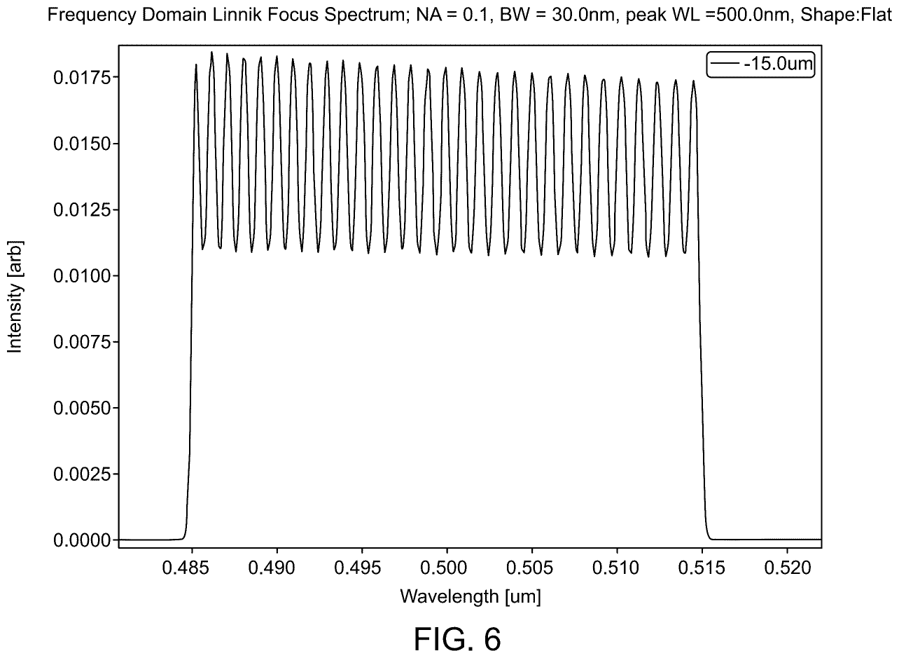

The focusing subsystem 103 may further comprise a spectrometer 140. The spectrometer 140 may be configured to generate an interference signal based on the collocated light 121 reflected by the sample 101 and the reference mirror 130. For example, a second beam splitter 123 may be disposed on the path of the collocated light 121, and the second beam splitter 123 may be configured to direct a portion 141 of the light 121 to be received by the spectrometer 140. The second beam splitter 123 may split the light 121 such that a portion of the light 121 (e.g., 10%, 20%, 30%, or more) is directed to the spectrometer 140, while the remaining portion of the light 121 is directed to the camera 120. The second beam splitter 123 may be arranged a distance from the main objective lens 114 of two times the focal length of the main objective lens 114. The interference signal generated by the spectrometer 140 may be a time-domain (spectral) signal, as shown in FIG. 6. A fiber connector head 142 (e.g., ferule) connected to the spectrometer 140 by an optical fiber 143 may be configured to receive the light 141 to be measured by the spectrometer 140.

One or more optical components may be disposed in the path of the light 141 incident on the fiber connector head 142. For example, a first lens 144 and a second lens 145 may be arranged in the path of the light 141 incident on the fiber connector head 142. A field stop 146 may be disposed in the path of the light 141 between the first lens 144 and the second lens 145. The field stop 146 may be arranged at a distance from the first lens 144 equal to the focal length of the first lens 144. The field stop 146 may be configured to set the field of the of the focusing subsystem 103 by blocking a region of the sample 101, which can improve the interference spectrum contrast at the spectrometer. An aperture stop 147 may be disposed in the path of the light 141 between the field stop 146 and the second lens 145. The aperture stop 147 can be various shapes (e.g., an annular shape or other shapes). The aperture stop 147 may be arranged at a distance from the first lens 144 equal to two times the focal length of the first lens 144, while the first lens 144 may be a distance that is twice its focal length from the pupil plane of the main objective lens 114. The arrangement of the optical components in the path of the light 141 incident on the fiber connector head 142 may be configured such that the pupil of the main objective lens 114 is projected on to the aperture stop 147, which may set the effective numerical aperture (NA) of the focusing subsystem 103. A smaller NA may increase the operating range of the focusing subsystem 103, while a larger NA can increase the number of photons received by the spectrometer 140, which can shorten the exposure time and improve focusing speed. For example, the aperture stop 147 may provide an effective NA of 0.01, 0.05, 0.1, 0.15, 0.2, 0.25, 0.3, 0.35, 0.4, 0.45, 0.5, 0.55, 0.6, 0.65, 0.7, 075, 0.8, 0.85, 0.9, 0.95, or any number or range of numbers therebetween. The focusing subsystem 103 may include additional optical components disposed in the path of the light 141 incident on the fiber connector head 142 and is not limited herein. For example, the focusing subsystem 103 may include one or more polarizers, apodizers, filters (e.g., short-pass, long-pass, band-pass, neutral density, etc.) or other optical elements.

In some embodiments, the focusing subsystem 103 may include different arrangements lenses and other optical components. For example, focusing subsystem 103 may include a three-lens relay or a single lens with fixed magnification. The single lens may be configured to image the pupil of the main objective lens 114 directly onto the fiber connector head 142, such that the fiber connector head 142 can be used as an aperture stop to limit the effective NA of the focusing subsystem 103. Alternatively, the single lens could be positioned such that the field of the main objective lens 114 would be projected onto the fiber connector head 142, such that the effective NA of the focusing subsystem 103 would be identical to the NA of the imaging subsystem 102, and the focus range would be dictated by the microscope objective's illumination NA, which can be effective for low NA imaging.

In some embodiments, the focusing subsystem 103 may by a Linnik interferometry system or other type of interferometry system and is not limited herein.

The system 100 may further comprise a processor 150. The processor 150 may include a microprocessor, a microcontroller, FPGA, or other devices.

The processor 150 may be coupled to the components of the system 100 in any suitable manner (e.g., via one or more transmission media, which may include wired and/or wireless transmission media) such that the processor 150 can receive output. The processor 150 may be configured to perform a number of functions using the output. An inspection tool can receive instructions or other information from the processor 150. The processor 150 optionally may be in electronic communication with another inspection tool, a metrology tool, a repair tool, or a review tool (not illustrated) to receive additional information or send instructions.

The processor 150 may be part of various systems, including a personal computer system, image computer, mainframe computer system, workstation, network appliance, internet appliance, or other device. The subsystem(s) or system(s) may also include any suitable processor known in the art, such as a parallel processor. In addition, the subsystem(s) or system(s) may include a platform with high-speed processing and software, either as a standalone or a networked tool.

The processor 150 may be disposed in or otherwise part of the system 100 or another device. In an example, the processor 150 and may be part of a standalone control unit or in a centralized quality control unit. Multiple processors 150 may be used, defining multiple subsystems of the system 100.

The processor 150 may be implemented in practice by any combination of hardware, software, and firmware. Also, its functions as described herein may be performed by one unit, or divided up among different components, each of which may be implemented in turn by any combination of hardware, software and firmware. Program code, instructions, configuration data, lookup tables, calibration data, and algorithms, etc., for the processor 150 to implement various methods and functions may be stored in readable storage media, such as a memory.

If the system 100 includes more than one subsystem, then the different processors 150 may be coupled to each other such that images, data, information, instructions, etc. can be sent between the subsystems. For example, one subsystem may be coupled to additional subsystem(s) by any suitable transmission media, which may include any suitable wired and/or wireless transmission media known in the art. Two or more of such subsystems may also be effectively coupled by a shared computer-readable storage medium (not shown).

The processor 150 may be configured to perform a number of functions using the output of the system 100 or other output. For instance, the processor 150 may be configured to send the output to an electronic data storage unit or another storage medium. The processor 150 may be further configured as described herein.

The processor 150 may be configured according to any of the embodiments described herein. The processor 150 also may be configured to perform other functions or additional steps using the output of the system 100 or using images or data from other sources.

The processor 150 may be communicatively coupled to any of the various components or sub-systems of system 100 in any manner known in the art. Moreover, the processor 150 may be configured to receive and/or acquire data or information from other systems (e.g., inspection results from an inspection system such as a review tool, a remote database including design data and the like) by a transmission medium that may include wired and/or wireless portions. In this manner, the transmission medium may serve as a data link between the processor 150 and other subsystems of the system 100 or systems external to system 100. Various steps, functions, and/or operations of system 100 and the methods disclosed herein are carried out by one or more of the following: electronic circuits, logic gates, multiplexers, programmable logic devices, ASICs, FPGAs, analog or digital controls/switches, microcontrollers, or computing systems. Program instructions implementing methods such as those described herein may be transmitted over or stored on carrier medium. The carrier medium may include a storage medium such as a read-only memory, a random-access memory, a magnetic or optical disk, a non-volatile memory, a solid-state memory, a magnetic tape, and the like. A carrier medium may include a transmission medium such as a wire, cable, PCB trace, or wireless transmission link. For instance, the various steps described throughout the present disclosure may be carried out by a single processor 150 (or computer subsystem) or, alternatively, multiple processors 150 (or multiple computer subsystems). Moreover, different sub-systems of the system 100 may include one or more computing or logic systems. Therefore, the above description should not be interpreted as a limitation on the present disclosure but merely an illustration.

The processor 150 may be in electronic communication with the imaging subsystem 102. For example, the processor 150 may be in electronic communication with the light source 110, and the processor 150 may be configured to send instructions to the light source 110 to turn on/off to emit light 111. The processor 150 may be in electronic communication with the camera 120, and the processor 150 may be configured to send instructions to the camera 120 to generate one or more images of the sample 101 based on the light 121 reflected by the sample 101.

The processor 150 may in electronic communication with the focusing subsystem 103. For example, the processor 150 may be in electronic communication with the spectrometer 140, and the processor 150 may be configured to receive the interference signal generated by the spectrometer 140. The processor 150 may be configured to transform the interference signal to obtain a frequency-domain signal. For example, the processor 150 may apply a Fourier transform, discrete Fourier transform (DFT), fast Fourier transform (FFT), or other function to the interference signal to transform the interference signal from the time (spectral) domain to the frequency (Fourier) domain. For processor 150 may be further configured to determine a defocus condition of the imaging subsystem 102 based on the frequency-domain signal. For example, the processor 150 may identify a local maximum of the frequency-domain signal that corresponds to the defocus condition of the imaging subsystem 102. The processor 150 may use a side lob peak finding algorithm or a center of mass algorithm to identify the local maximum of the frequency-domain signal. In some embodiments, the processor 150 may use a deep learning (AI) model to identify the local maximum of the frequency-domain signal. To train the AI model, a collection of spectrums, one per defocus position, can be collected across the entire wafer measurement sites and along a large enough defocus range, the collected spectrums can be labeled for their defocuses, and then an FFT function can be applied to the collected spectrums produce a training set for the AI model. The AI model can be used in run time (in HVM) to detect the defocus for any new wafer based on the measured frequency-domain signal.

The processor 150 may be in electronic communication with the sample stage 105 or the vertical stage. For example, the processor 150 may be configured to send instructions to the one or more actuators to move the sample stage 105 or the vertical stage in the axial direction based on the defocus condition. The one or more actuators may be configured to move the sample stage 105 (or the vertical stage) in increments as small as 10 nm It should be understood that focus of the imaging subsystem 102 may depend on the axial position of the main objective lens 114 and the sample 101, and thus moving the sample stage 105 or the vertical stage in the axial direction may bring the sample 101 in/out of focus with the imaging subsystem 102.

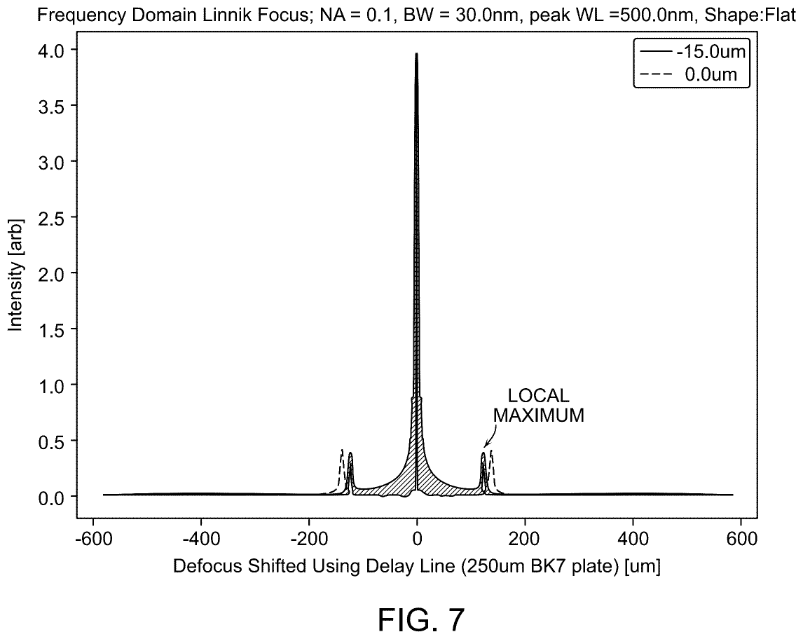

In an instance, the system 100 may be calibrated to a focused position, in which the portion of the sample 101 under inspection is in focus with the imaging subsystem 102. In the focused position, the processor 150 may store the interference signal generated by the spectrometer 104 and the location of the local maximum. When the imaging subsystem 102 is out of focus (i.e., the sample stage 105 or the vertical stage is in a defocused position) when inspecting any portion of the sample 101, the local maximum determined from the frequency-domain signal derived from the interference signal may be shifted compared to that of the focused position, as shown in FIG. 7. For example, the broken line in FIG. 7 indicates an interference signal in the focused position (e.g., a defocused condition of 0.0 μm), where the local maximum may be at about 150 μm, and the solid line indicates an interference signal in the defocused position (e.g., a defocused condition of-15.0 μm), where the local maximum may be at about 135 μm. Accordingly, the difference in the location of the local maximum in the defocused position from the focused position may correspond to the defocus condition of the imaging subsystem 102 (e.g., 135 μm-150 μm=−15.0 μm), and the processor 150 may be configured to send instructions to the one or more actuators to move the sample stage 105 or the vertical stage by the axial distance corresponding to the difference of the local maxima.

The processor 150 may be configured to send instructions to the camera 120 to capture the one or more images of the sample 101 after the sample stage 105 or the vertical stage is moved from the present defocused position to the focused position. Accordingly, the imaging subsystem 102 may capture the one or more images of the sample 101 when the sample 101 is in focus with the camera 120.

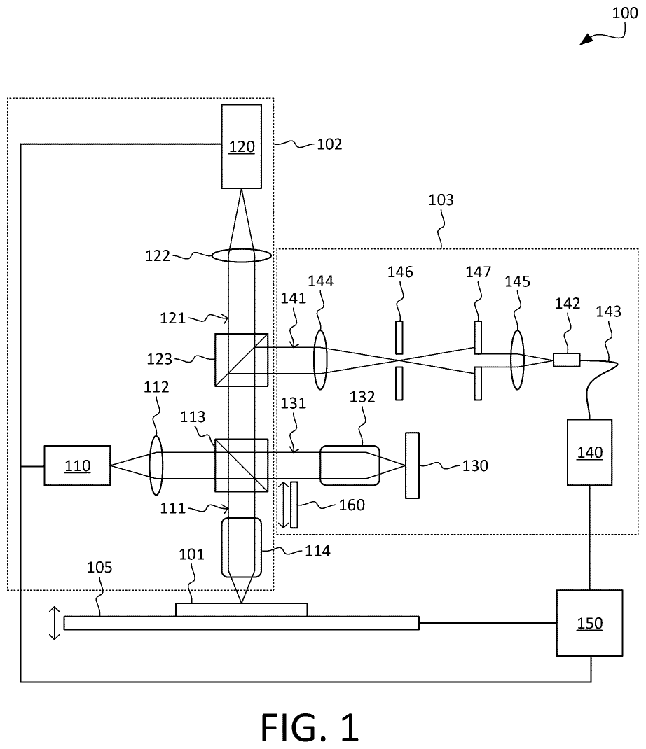

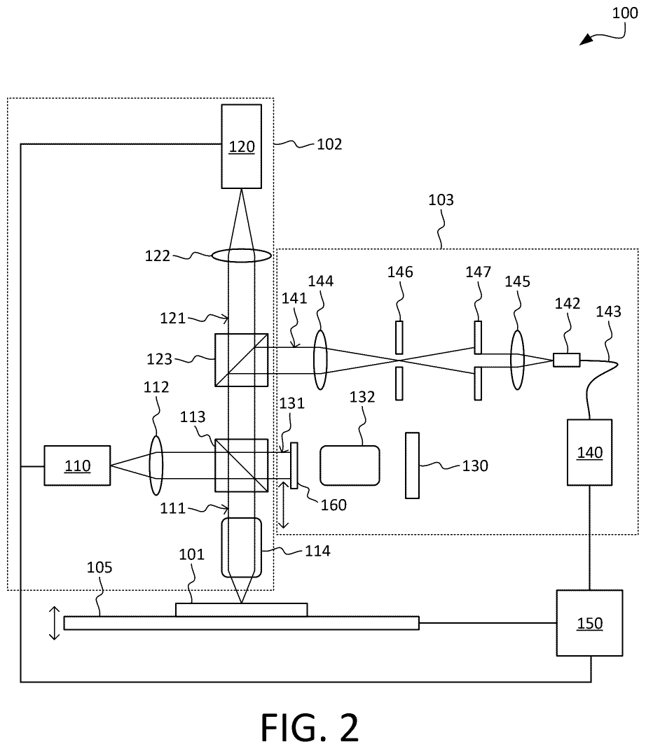

The focusing subsystem 103 may further comprise a shutter 160. The shutter 160 may be made of a stiff light metal or other material, and may be naturally dark (e.g., opaque) or can have a dark coating. The shutter 160 may be movable by one or more actuators in/out of the path of the light 131 reflected by the reference mirror 130. For example, in a first position (shown in FIG. 1), the shutter 160 may be disposed out of the path of the light 131 reflected by the reference mirror 130, so as to selectively allow the light 131 to be collocated with the light 121 reflected by the sample 101 and to be measured by the spectrometer 140. In a second position (shown in FIG. 2), the shutter 160 may be disposed in the path of the light 131 reflected by the reference mirror 130, so as to block the light 131 from being collocated with the light 121 reflected by the sample 101 and to not interfere with the imaging of the sample 101 by the camera 120. The processor 150 may be in electronic communication with the one or more actuators that are configured to move the shutter 160, and the processor 150 may be configured to send instructions to the one or more actuators to move the shutter 160 from the first position to the second position. For example, after determining the defocus condition of the imaging subsystem 102, the processor 150 may send instructions to the one or more actuators to move the shutter 160 to the second position. The one or more actuators may be pneumatic, electromagnetic, or motorized actuators and is not limited herein. In some embodiments, the one or more actuators may be a linear motor.

In some embodiments, the processor 150 may be configured to send instructions to the one or more actuators to move the shutter 160 from the first position to the second position simultaneously, or in parallel with, as the sample stage 105 or the vertical stage moves from the defocused position to the focused position. For example, the time for the one or more actuators to move the shutter 160 from the first position to the second position may be 10 ms to 40 ms, and the time for the sample stage 105 or the vertical stage to move from the defocused position to the focused position may be 10 ms to 30 ms. Accordingly, the time between focusing the imaging subsystem 102 and generating one or more images of the sample 101 may be reduced.

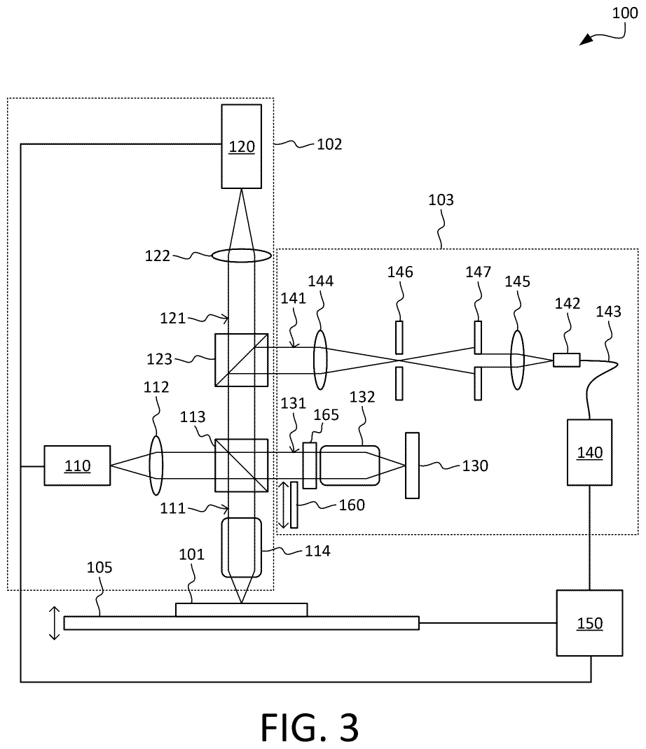

In some embodiments, the defocus of the imaging system 102 may be small, such that the location of the side lob/local maximum of the frequency-domain signal may be close to, or masked by, the main/zero-order maximum, and it may be difficult for the processor 150 to determine the defocused condition. To improve the ability of the algorithm to locate the local maximum, the focusing subsystem 103 may induce a phase delay in the interference signal, which separates the side lob/local maximum separated from the main/zero-order maximum, as shown in FIG. 7. The phase delay may be induced in the light 131 reflected by the reference mirror 130. In some embodiments, a glass block 165 may be disposed in the path of the light 131 reflected by the reference mirror 130, as shown in FIG. 3. The glass block 165 may refract the light 131 reflected by the reference mirror 130, which induces a phase delay between the light 121 reflected by the sample 101 and the light 131 reflected by the reference mirror 130. The glass block 165 may be made of any optical grade material and may or may not have a selectable coating. For example, the glass block 165 may be a BK7 glass block having a thickness of 200 μm. In other embodiments, the phase delay may be induced by varying the optical distance of the light 131 reflected by reference mirror 130 compared to the optical distance of the light 121 reflected by the sample 101. For example, an air gap may be present in the path of the light 131 reflected by the reference mirror 130, which can induce the phase delay. For example, the air gap may be 20 μm, 50 μm, 100 μm or more, or any number therebetween.

Using the inherent illumination of the imaging subsystem 102 (i.e., the light source 110) for determining the defocus condition with the focusing subsystem 103 may be advantageous, as the light source 110 operates at a wavelength band selected for inspection of the sample 101 being processed. However, in some instances, use of the light source 110 may result in the power collected by the spectrometer 140 being small, which can cause the exposure time of the spectrometer 140 to increase, thereby reducing the speed of detecting the defocus condition. In some instances of small defocus conditions, time to move the shutter 160 to the second position may be greater than the time to move the sample stage 105 or the vertical stage to the focused position, which can limit the minimum delay between focusing and imaging.

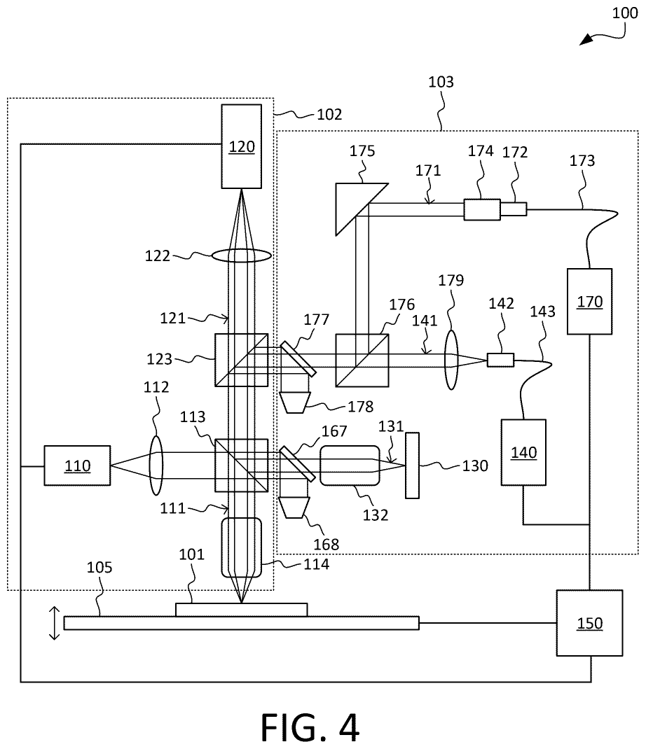

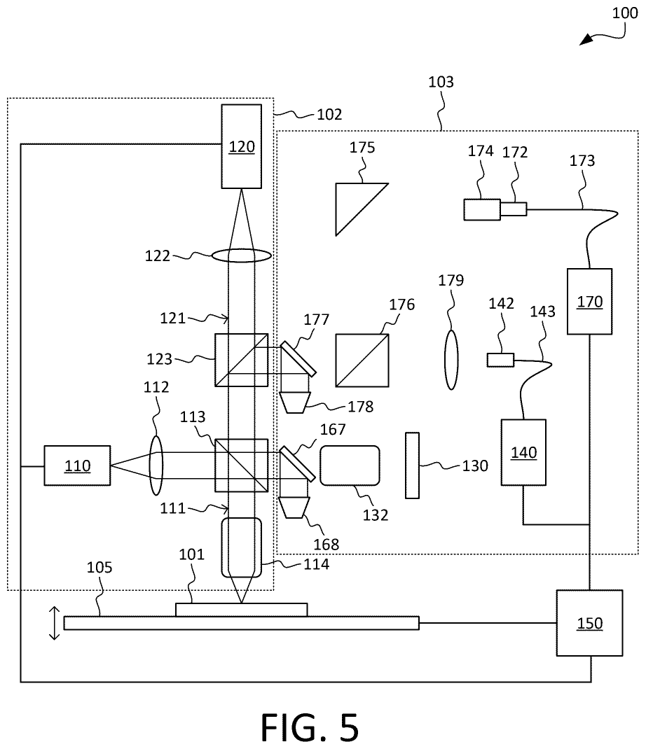

In some embodiments, the focusing subsystem 103 may further comprise a focusing light source 170, as shown in FIG. 4 and FIG. 5. The focusing light source 170 may be a super luminescence diode (SLD), laser-sustained plasma, super continuum laser, flash lamp, halogen lamp, or other type of light source. For example, SLDs may be intense light sources that can be easily collimated and projected to specified location and can be less sensitive to the sample 101 than single wavelength light sources. The illumination spectrum of the focusing light source 170 may be different from the light source 110 of the imaging system 102. For example, the illumination spectrum of the light source 110 may be from 300 nm to 800 nm, while the illumination spectrum of the focusing light source 170 may be centered at about 835 nm with a full width at half maximum (FWHM) Gaussian-like spectrum of 45 nm. Alternatively, the focusing light source 170 may be centered ta 1050 nm with a FWHM bandwidth of 50 nm, while the illumination spectrum of the light source 110 may be 300 nm to 1000 nm. In some embodiments, the focusing light source 170 may comprise a plurality of SLDs each having a different illumination spectrum that are combined using a fiber coupler (e.g., N×1 fiber coupler).

The focusing light source 170 may be configured to emit a focus light 171 that is reflected by the sample 101 and the reference mirror 130 and received by the spectrometer 140 to generate the interference signal. For example, the focusing light source 170 may be connected to a focus fiber connector head 172 by a focus fiber 173, and the focus fiber connector head 172 may be connected to a collimator 174. The collimator 174 may be configured to shape the focus light 171 into a uniform spot or keep the shape as a Gaussian distributed beam. The diameter of the focus light 171 may be shaped to any size based on the effective NA of the focusing subsystem 103. The focus light 171 exiting the collimator 174 may be directed to a mirror 175 and a third beam splitter 176, which directs the focus light 171 to the second beam splitter 123 and the first beam splitter 113, such that a portion of the focus light 171 is directed to the sample 101 and another portion of the light is directed to the reference mirror 130. The focus light 171 may be reflected by the sample 101 and reference mirror 130, and the collocated light 141 can be directed to be received by the spectrometer 140 by the second beam splitter 123. A single lens 179 may be disposed in the path of the light 141 incident on the fiber connector head 142 or one or more optical components can be included as described above. The optical assembly using collimated beam projection may only use a single lens 179 (compared to several lenses) since the spot size and the focus range (i.e., effective NA) of the collocated light 141 can be directly determined by the diameter of the focus light 171. Accordingly, the beam size and other factors may be defined by the collimator 174, without further shaping optics in the path of the collocated light 141.

The processor 150 may be configured to send instructions to the focusing light source 170 to turn off after determining the defocus condition. For example, FIG. 4 illustrates the system 100 with the focusing light source 170 turned on, while FIG. 5 illustrates the system 100 with the focusing light source 170 turned off. The focusing light source 170 can be turned off in a shorter amount of time compared to the movement of the sample stage 105 or the vertical stage, such that small defocus conditions can be corrected quickly and improve throughput. In addition, the spectrometer 140 may be able to determine the defocus condition after a short exposure time (e.g., 1 ms or less), which can be quicker than using the light source 110 of the imaging system 102. By turning off the focusing light source 170, no shutter 160 may be needed to block the reflected light 131 from the reference mirror 130 during imaging, which avoids the use of a moving part and improves throughput time.

In some embodiments, the light source 110 may be kept on and configured to emit light 111 while the focusing light source 170 emits the focus light 171. Accordingly, to avoid masking of the interference signal, the focusing subsystem 103 may further comprise one or more filters to separate the light 111 from the focus light 171 from reaching the reference mirror 130 and the spectrometer 140. For example, a first filter 167 may be disposed in the path of the light 131 incident on the reference mirror 130, and a second filter 177 may be disposed in the path of the light 141 incident on the fiber connector head 142. The first filter 167 and the second filter 177 may be dichroic mirrors. For example, the first dichroic mirror 167 and the second dichroic mirror 177 may be configured to transmit wavebands corresponding to the focus light 171 of the focusing light source 170 and reflect wavebands corresponding to the light 111 of the light source 110. The focusing subsystem 103 may further comprise a first beam dump 168 configured to receive the light 111 from the light source 110 reflected by the first dichroic mirror 167 and a second beam dump 178 configured to receive the light 111 from the light source reflected by the second dichroic mirror 177. The first dichroic mirror 167 may be further configured to induce a phase delay in the light reflected by the reference mirror 130, similar to the glass block 165 described above. The first dichroic mirror 167 may have a relatively small thickness, such as, for example, 200 μm, 250 μm, or 350 μm or any number therebetween. In some embodiments, the second beam splitter 123 may be replaced with a dichroic mirror that is configured to reflect wavebands corresponding to the focus light 171 of the focusing light source 170 and transmit wavebands corresponding to the light 111 of the light source 110, which may improve the light budget as there may be minimal light lost when being reflected or transmitted by the dichroic mirror.

In some embodiments, the focusing subsystem 103 may further comprise a plurality of focusing light sources having different bandwidths. For example, the focusing light source 170 may be one of the plurality of focusing light sources, or the focusing light source 170 itself may comprise a plurality of focusing light sources. The processor 150 may be configured to send instructions to turn on one of the plurality of focusing light sources based on the wavelength spectrum of the light from the light source 110 of the imaging subsystem 102. For example, the processor 150 may select a focusing light source 170 having a bandwidth nearest to, but not the same as, the bandwidth of the light source 110. In an instance, the plurality of focusing light sources may include an SLD with center wavelength of 1050 nm and FWHM bandwidth of 50 nm, an SLD with center wavelength of 835 nm and FWHM of 45 nm, and an SLD with center wavelength of 600 nm and FWHM of 30 nm, or any number of additional focusing light sources having different bandwidths. In this example, the first dichroic mirror 167 and the second dichroic mirror 177 may be selected to transmit the SLD bandwidth and reflect the illumination bandwidth. For example, the first dichroic mirror 167 and the second dichroic mirror 177 may be configured to reflect a spectrum below 1000 nm, below 800 nm, or below 550 nm, or other wavebands. In some embodiments, the first dichroic mirror 167 and the second dichroic mirror 177 may be multi-dichroic mirrors configured for transmission of each of the plurality of focusing light sources when selected by the processor 150.

The principle of operation of the system 100 may be established on the theory of two beam interference. For simplicity, assuming the focusing subsystem 103 is a Linnik interferometry system operated with super low NA objectives, the Linnik interferometry system may be regarded as a Michelson interferometry system. Under these circumstances, the field coming from the sample 101 and reference mirror 130 may be as follows:

$${E}_{o} = {r}_{o} {E}_{0} ( k ) exp \{ j [ - 2 k ( d + f ) + {φ}_{o} ( k ) ] \} \qquad ( 1 )$$

$${E}_{r} = {r}_{r} {E}_{0} ( k ) exp [ j ( - 2 kf + {φ}_{r} ( k ) ) ] \qquad ( 2 )$$

The interference signal can be expressed as:

$$I ( k ) ∝ {\vert {E}_{o} + {E}_{r} \vert}^{2} = {\vert {E}_{o} \vert}^{2} + {\vert {E}_{r} \vert}^{2} + 2 R e a l [ {E}_{o} \cdot {E}_{r}^{*} ] \qquad ( 3 )$$

In Equations (1) to (3) above, E₀(k) is the amplitude of the source of the field per wavelength and f is the focal length, d is the defocus, φₒ and φᵣ constant phases related to the interferometer arms optical path distance (typically 2 kL with L being the arm length and k being the wavenumber), rᵣ and rₛ are the reflectivity of the sample 101 and reference mirror 130. For a balanced interferometer (φₒ equal φᵣ) Equations (1) and (2) can be combined with Equation (3) to obtain the expression for the interference signal (I) per wavelength (k=2π/λ) and defocus condition:

$$I ( k , d ) ∝ {E ( k )}_{0}^{2} [ 1 + \frac{2 {r}_{o} {r}_{r}}{{r}_{o}^{2} + {r}_{r}^{2}} cos ( 2 k d ) ] ∝ s ( k ) [ 1 + γ cos ( 2 k d ) ] \qquad ( 4 )$$

The interference signal may be a raised cosine with a contrast equal to γ, a frequency equal to d/π and a modulation determined by the source spectrum, s(k). By taking the Fourier transform of Equation (4) with s(k) being a flat source, the result is as follows:

$$D ( z ) ∼ {sinc}^{2} ( 2 π z Δ \overline{k} ) + \frac{{γ}^{2}}{4} {sinc}^{2} [ 2 π ( z - d ) Δ \overline{k} ] + \frac{{γ}^{2}}{4} {sinc}^{2} [ 2 π ( z + d ) Δ \overline{k} ] \qquad ( 5 )$$

In Equation (5) above,

$$Δ \overline{k} = \frac{{k}_{max} - {k}_{min}}{2}$$

z is the vertical axis in the Fourier domain, and

$$γ = \frac{2 {r}_{o} {r}_{r}}{{r}_{o}^{2} + {r}_{r}^{2}} .$$

With Equation (5), the defocus value (d) can be derived by locating either the positive or the negative side lobs of the Fourier transform of the signal, D(z). In particular, the interference spectrum I(k, d) is captured using the spectrometer 140 while the defocus signal D(z) is obtained by applying the FFT operation on the interference spectrum. The defocus signal is then processed by a side lob peak finding algorithm or a center of mass finding algorithm to calculate the defocus condition. In some embodiments, a deep learning (AI) model can be used to learn the peak position. For small defocus conditions, the side lobs can be pushed away from the zero-order main lob by introducing a phase delay in the reference arm, which allows calculating the defocus condition for both small and large defocus values, either negative or positive, and without any ambiguity.

While the above analysis applies to Michelson interferometry, the principles of operation can be applied to more complex arrangements for Linnik interferometry and other interferometry systems, in which the objectives introduce an angular content which affect the interference signal. In addition, the reflectivity of both the reference mirror 130 and the sample 101 may be dependent on the objective NA and the wavelength used. Accordingly, the system 100 may be modified to adapt to different samples and different focus conditions with different illumination bandwidths to improve the interference signal captured by the spectrometer 140 and improve the accuracy of calculating the defocus condition.

With the system 100, fast focusing of the imaging subsystem can be attained using the same illumination spectrum as the illumination light source 110 or using a dedicated focusing light source 170. By reducing the number of mechanical moving parts, the system 100 can also have improved focus repeatability, speed, and accuracy.

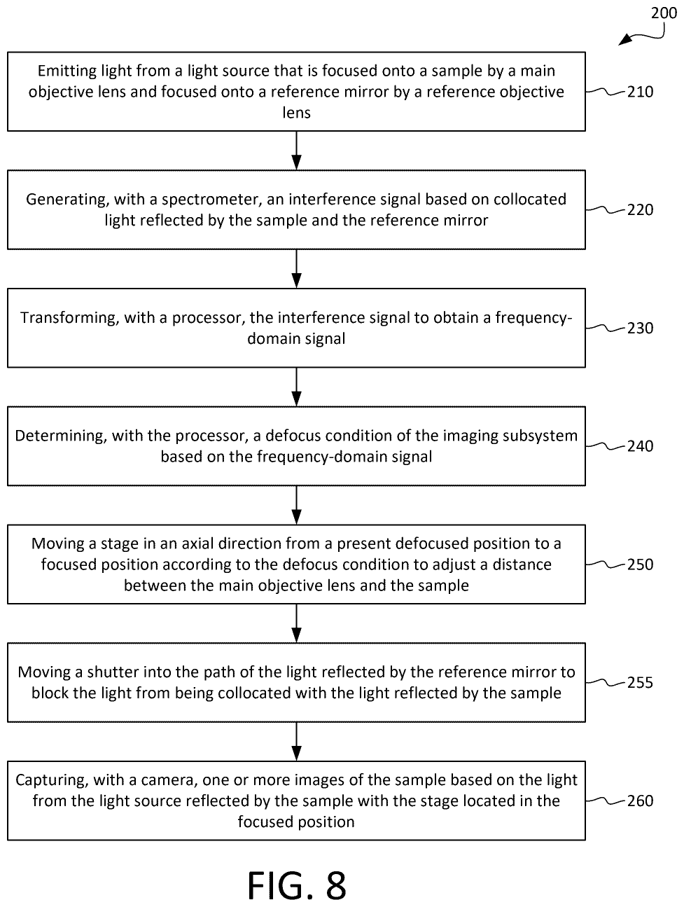

Another embodiment of the present disclosure provides a method 200 for focusing an imaging subsystem. As shown in FIG. 8, the method 200 may comprise the following steps.

At step 210, light is emitted from a light source. The light is reflected by a sample and reflected by a reference mirror into a collocated light path.

At step 220, a spectrometer generates an interference signal based on the collocated light reflected by the sample and the reference mirror. The interference signal may be a time-domain signal. For example, the interference signal may be the time-domain signal shown in FIG. 6.

At step 230, a processor transforms the interference signal to obtain a frequency-domain signal. In some embodiments, the processor may transform the interference signal by applying a Fourier transform to the interference signal to obtain the frequency-domain signal. For example, the frequency-domain signal may be the signal shown in FIG. 7.

At step 240, the processor determines a defocus condition of the imaging subsystem based on the frequency-domain signal. In some embodiments, the processor may determine the defocus condition of the imaging subsystem based on a local maximum of the frequency domain signal. For example, the processor may use a side lob finding algorithm or a center of mass finding algorithm to find the local maximum. In an instance, the imaging subsystem may be calibrated to a focused position, and the location of the local maximum of the frequency domain signal may be stored. In subsequent focusing measurements, the defocus condition may correspond to the difference in the side lob position of the presently measured frequency domain signal compared to the stored frequency domain signal.

In some embodiments, the method 200 may further comprise step 250. At step 250, a stage is moved in an axial direction from a present defocused position to a focused position according to the defocused condition to adjust a distance between the main objective and the sample. The stage may be a sample stage configured to hold the sample or a vertical stage configured to hold the main objective lens, such that movement of the stage in the axial direction adjusts the distance between the main objective and the sample. For example, the stage may be moved by a distance corresponding to the difference between the side lob position of the presently measured frequency domain signal and the stored frequency domain signal of the calibrated focused position.

In some embodiments, the method 200 may further comprise step 255. At step 255, a shutter is moved into the path of the light reflected by the reference mirror to block the light from being collocated with the light reflected by the sample. In an instance, step 255 may be performed in parallel with step 250, such that the shutter is moved simultaneously with moving the stage.

In some embodiments, the method 200 may further comprise step 260. At step 260, a camera captures one or more images of the sample based on the light from the light source reflected by the sample with the stage located in the focused position.

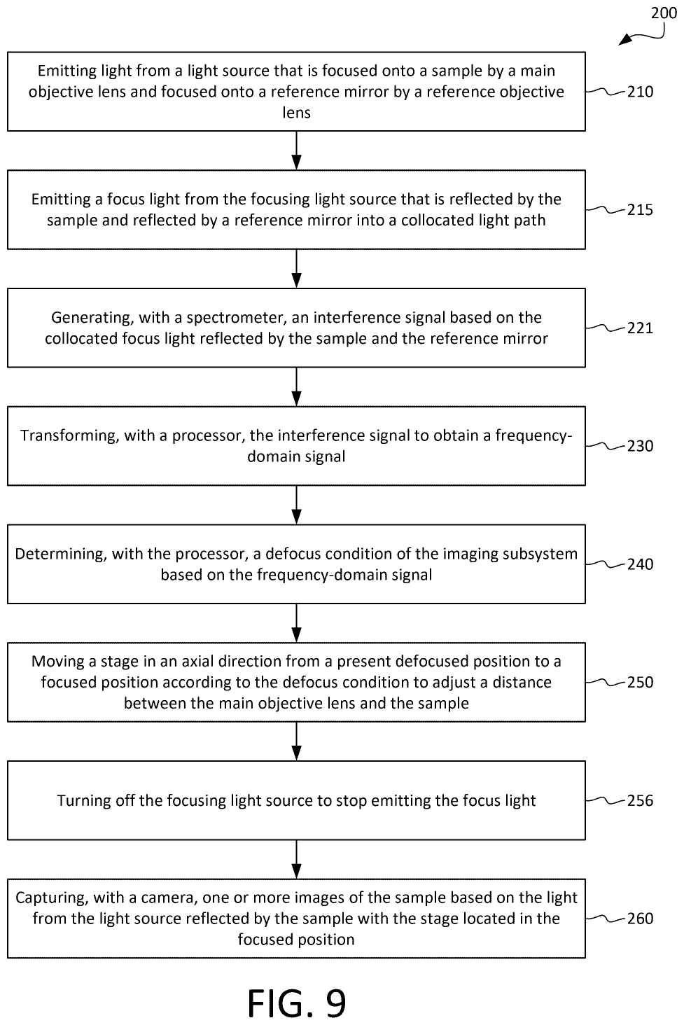

In some embodiments, the method 200 may further comprise step 215, as shown in FIG. 9. At step 215, a focus light is emitted with a focusing light source. The focus light may have a different wavelength spectrum from the light from the light source. The focus light may be reflected by the sample and reflected by the reference mirror into the collocated light path. A first filter may be disposed in the path of the focus light reflected by the reference mirror. The first filter may be configured to transmit the focus light from the focusing light source to be reflected by the reference mirror and reflect the light from the light source of the imaging subsystem toward a first beam dump. A second filter may be disposed in the path of the collocated focus light reflected by the sample and the reference mirror. The second filter may be configured to transmit the reflected focus light to be received by the spectrometer and reflect the light from the light source toward a second beam dump. The first filter and the second filter may be dichroic mirrors.

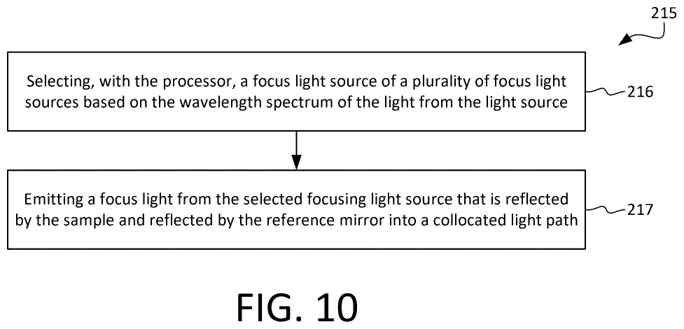

In some embodiments, step 215 may comprise step 216 and 217, as shown in FIG. 10. At step 216, the processor selects a focusing light source of a plurality of focusing light sources based on the wavelength spectrum of the light from the light source of the imaging subsystem. Each of the plurality of focusing light sources may have different bandwidths. The processor may select a focusing light source having a bandwidth that is nearest to, but not overlapping with, the wavelength spectrum of the light from the light source of the imaging system. At step 217, the selected focusing light source emits a focus light that is reflected by the sample and reflected by the reference mirror into a collocated light path.

In some embodiments, step 220 may comprise step 221, as shown in FIG. 9. At step 221, the spectrometer generates an interference signal based on the collocated focus light reflected by the sample and the reference mirror.

In some embodiments, before step 260, the method 200 may further comprise step 256. At step 256, the focusing light source is turned off to stop emitting the focus light. Thus, the one or more images of the sample can be captured in step 260 without the interference of the focus light.

With the method 200, fast focusing of the imaging subsystem can be attained using the same illumination spectrum as the illumination light source or using a dedicated focusing light source. By reducing the number of mechanical moving parts, the method 200 can also have improved focus repeatability, speed, and accuracy.

Although the present disclosure has been described with respect to one or more particular embodiments, it will be understood that other embodiments of the present disclosure may be made without departing from the scope of the present disclosure. Hence, the present disclosure is deemed limited only by the appended claims and the reasonable interpretation thereof.

What is claimed is:

1. A system comprising:
an imaging subsystem, comprising:
a light source configured to emit light;
a main objective lens configured to focus the light onto a sample; and
a camera configured to generate one or more images of the sample based on the light emitted from the light source reflected by the sample;
a focusing subsystem, comprising:
a reference objective lens configured to focus a portion of the light onto a reference mirror, wherein the reference mirror is configured to reflect light to be collocated with the light reflected by the sample; and
a spectrometer configured to generate an interference signal based on the collocated light reflected by the sample and the reference mirror, wherein the interference signal is a time-domain signal; and
a processor in electronic communication with the spectrometer, wherein the processor is configured to:
transform the interference signal to obtain a frequency-domain signal; and
determine a defocus condition of the imaging subsystem based on the frequency-domain signal.

2. The system of claim 1, wherein the processor is configured to transform the interference signal by applying a Fourier transform to the interference signal, and the processor is configured to obtain the defocus condition by determining a local maximum of the frequency-domain signal using a side lob peak finding algorithm, a center of mass algorithm, or a deep learning model.

3. The system of claim 1, wherein the focusing subsystem further comprises:
a glass block disposed in a path of the light reflected by the reference mirror, wherein the glass block is configured to induce a phase delay between the light reflected by the sample and the light reflected by the reference mirror.

4. The system of claim 1, wherein the imaging subsystem further comprises:
a stage configured to move in an axial direction to adjust a distance between the main objective lens and the sample, wherein the defocus condition comprises an axial distance between a present defocused position and a focused position in which the imaging subsystem is in focus with the sample;
wherein the processor is in electronic communication with one or more actuators configured to move the stage in the axial direction, and the processor is further configured to:
send instructions to the one or more actuators to move the stage from the present defocused position to the focused position.

5. The system of claim 4, wherein the focusing subsystem further comprises:
a shutter that is movable within a path of the light reflected by the reference mirror to selectively allow the light to be collocated with the light reflected by the sample in a first position and block the light from being collocated with the light reflected by the sample in a second position;
wherein the processor is in electronic communication with one or more actuators configured to move the shutter, and the processor is further configured to:
send instructions to the one or more actuators to move the shutter from the first position to the second position after determining the defocus condition of the imaging subsystem.

6. The system of claim 5, wherein the processor is configured to send instructions to the one or more actuators to move the shutter from the first position to the second position simultaneously as the stage moves from the defocused position to the focused position.

7. The system of claim 4, wherein the processor is in electronic communication with the camera, and the processor is further configured to send instructions to the camera to capture the one or more images of the sample after the stage is moved from the present defocused position to the focused position.

8. The system of claim 4, wherein the focusing subsystem further comprises:
a focusing light source configured to generate a focus light of a different wavelength spectrum from the light from the light source of the imaging subsystem, wherein the focus light is reflected by the sample and the reference mirror;
a first filter disposed in a path of the focus light reflected by the reference mirror, wherein the first filter is configured to transmit the focus light from the focusing light source to be reflected by the reference mirror and reflect the light from the light source of the imaging subsystem toward a first beam dump; and
a second filter disposed in a path of the collocated focus light reflected by the sample and the reference mirror, wherein the second filter is configured to transmit the reflected focus light to be received by the spectrometer and reflect the light from the light source of the imaging subsystem toward a second beam dump;
wherein the spectrometer is configured to generate the interference signal based on the collocated focus light reflected by the sample and the reference mirror.

9. The system of claim 8, wherein the first filter is further configured to induce a phase delay between the focus light reflected by the sample and the focus light reflected by the reference mirror.

10. The system of claim 8, wherein the processor is in electronic communication with the focusing light source, and the processor is further configured to send instructions to turn off the focusing light source after the stage is moved from the present defocused position to the focused position.

11. The system of claim 8, wherein the focusing subsystem comprises a plurality of focusing light sources having different bandwidths, and the processor is further configured to send instructions to turn on one of the plurality of focusing light sources based on the wavelength spectrum of the light from the light source of the imaging subsystem.

12. A method for focusing an imaging subsystem comprising:
emitting light from a light source that is focused onto a sample by a main objective lens and focused onto a reference mirror by a reference objective lens, wherein the light is reflected by the sample and reflected by the reference mirror into a collocated light path;
generating, with a spectrometer, an interference signal based on the collocated light reflected by the sample and the reference mirror, wherein the interference signal is a time-domain signal;
transforming, with a processor, the interference signal to obtain a frequency-domain signal; and
determining, with the processor, a defocus condition of the imaging subsystem based on the frequency-domain signal.

13. The method of claim 12, wherein:
transforming, with the processor, the interference signal to obtain the frequency-domain signal comprises:
applying a Fourier transform to the interference signal; and
determining, with the processor, the defocus condition of the imaging subsystem based on the frequency-domain signal comprises:
determining the defocus condition of the imaging subsystem based on a local maximum of the frequency-domain signal.

14. The method of claim 12, further comprising:
moving a stage in an axial direction from a present defocused position to a focused position according to the defocus condition to adjust a distance between the main objective lens and the sample.

15. The method of claim 14, further comprising:
moving a shutter into a path of the light reflected by the reference mirror to block the light from being collocated with the light reflected by the sample.

16. The method of claim 15, wherein the shutter is moved simultaneously with the stage.

17. The method of claim 14, further comprising:
capturing, with a camera, one or more images of the sample based on the light from the light source reflected by the sample with the stage located in the focused position.

18. The method of claim 17, further comprising:
emitting a focus light with a focusing light source, wherein the focus light has a different wavelength spectrum from the light from the light source, and the focus light is reflected by the sample and reflected by the reference mirror into the collocated light path;
wherein a first filter disposed in a path of the focus light reflected by the reference mirror is configured to transmit the focus light from the focusing light source to be reflected by the reference mirror and reflect the light from the light source of the imaging subsystem toward a first beam dump;
wherein a second filter disposed in a path of the collocated focus light reflected by the sample and the reference mirror is configured to transmit the reflected focus light to be received by the spectrometer and reflect the light from the light source of the imaging subsystem toward a second beam dump; and
wherein generating, with the spectrometer, the interference signal based on the collocated light reflected by the sample and the reference mirror comprises:
generating an interference signal based on the collocated focus light reflected by the sample and the reference mirror.

19. The method of claim 18, wherein emitting the focusing light with the focusing light source comprises:
selecting, with the processor, one focusing light source of a plurality of focusing light sources based on the wavelength spectrum of the light from the light source of the imaging subsystem, wherein each of the plurality of focusing light sources have different bandwidths; and
emitting the focusing light with the selected focusing light source.

20. The method of claim 18, wherein before capturing, with the camera, the one or more images of the sample, the method further comprises:
turning off the focusing light source to stop emitting the focus light.
